(19) United States
(12) Patent Application Publication
(10) Pub. No.: US 2013/0029825 A1
(43) Pub. Date: Jan. 31, 2013

(54) Apparatus and Method for Producing Printed Articles

(71) Applicant: David G. Rich, Yorkshire (GB)

(72) Inventor: David G. Rich, Yorkshire (GB)

(73) Assignee: DS SMITH PACKAGING LIMITED, Berkshire (GB)

(21) Appl. No.: 13/544,579

(22) Filed: Jul. 9, 2012

(30) Foreign Application Priority Data
Jul. 28, 2011 (GB) GB1113094.5

(51) Int. Cl. B41F 13/56; B31B 1/14; B31F 1/00

(52) U.S. Cl. 493/324; 493/395; 493/340

(57) ABSTRACT

A sheet processing apparatus that is adapted to receive or include at least one sheet input roll, and a substantially continuous sheet of material fed therefrom. The apparatus includes sheet processing equipment for processing the sheet after it has been unrolled off the input roll and at least one digital printer adapted to print a surface of the substantially continuous sheet within the sheet processing apparatus.

### CROSS-REFERENCE TO RELATED APPLICATIONS

The priority benefit of Great Britain Patent Application Number 1113094.5, filed on Jul. 28, 2011, is hereby claimed and the entire contents thereof are incorporated herein by reference.

### FIELD OF DISCLOSURE

The present disclosure relates to an apparatus and method for producing printed articles, involving printing onto sheets of print-receiving medium, the medium having been unrolled from a roll of said print-receiving medium. By means of the printing process, text or images are printed onto one or more surfaces of the sheet or film prior to cutting or processing of said sheet.

### BACKGROUND

Printing machines are known that unroll a print-receiving medium from bulk rolls, e.g. kraft paper rolls, and which print the desired images or text onto the print-receiving medium as it passes through the printing machine, and some of these machines can operate at high speeds. For example, rotary screen printing machines have been developed that can print multicolor images onto either one or both sides of an unrolled sheet of paper prior to then rolling the sheet back up again, ready for transportation to a subsequent sheet processing apparatus. See FIG. 1 for a schematic view of such a printing process. Such printing machines can operate at fast sheet-feed speeds, such as speeds in excess of 100 meters per minute (100 mpm), and in many circumstances at speeds in excess of 200 mpm, or even 300 mpm, and with a print width in excess of 2 meters-2.4 m, or even 2.8 m, is an existing width for such rotary screen printing machines.

A drawback with rotary screen printing, however, is that it is difficult or impossible to vary the printed image from one printed image run to the next, on the fly. That is because the image on the screen print roller is fixed. Further there is inevitably a slow changeover time between printing one image run and another because to change from one image run to another, the screen print roller needs to changed. Further, even though a store of different screen print rollers and automated (or semi-automated) screen print roller swapping equipment can be provided or developed, and even though they might be able to improve switchover times compared to more manual approaches, the switchover time is still not going to be faster than the time it takes to print two consecutive images at the high printing speeds mentioned above, i.e. it won't be substantially instantaneous, even for 100 mps printing machines. That is because the rollers are large, and too massive to move at the speeds required. Indeed, typical changeover times in such equipment, using manual processes, are commonly as long as at least 45 minutes!

It would be desirable, therefore, to provide a printing machine in which print run (or repeating image) changes can be fast, or even substantially instantaneous, and it would be especially desirable if this could be achieved on a machine operating with a printing width of more than 1 m, and more preferably one of over 1.4 m, 2 m, or even 2.4 m, and/or one with one or more sheet feed rollers having a diameter of more than 300 mm, or more preferably a diameter of more than 500 mm, or even one of at least 1000 mm, again with sheet-feed speeds in excess of 100 mpm, or more preferably 200 mpm, or even 300 mpm.

A further problem with rotary screen printing is that it is difficult to incorporate multiple different colors into the screen print process. Rotary screen print equipment using six color screen print processing is known, and is in use in the printing of cover sheets for corrugated cardboard, and the print resolutions are such that color graduations are achievable using those six colors. As a result, high quality images are achievable. However, blending colors on that equipment is typically not possible due to the printing speeds involved. Therefore, the colors have to be chosen to be appropriate for a particular screen printing run. As a result, subsequent print runs, in addition to requiring different screen print rollers, may require different ink colors as well. It would be desirable, therefore, also to overcome this deficiency.

Yet a further problem with screen print printing is that it is difficult to run separate print jobs simultaneously. This is because screen print rollers are typically designed for a particular print run, with repeats of the same image arranged side-by-side and/or around the circumference of the roller. As a result, for each rotation of the roller, a plurality of desired, corresponding, i.e. matching, printed images are printed onto the print receiving medium, and those images are presented in the form of a regular array. This facilitates the later cutting out of the finished products. However, this arrangement means that print jobs are necessarily run sequentially, and with inevitable breaks in the process as the print rollers are changed over.

Due to the breaks (i.e. pauses) in the printing process, this format of printing is unsuitable for efficiently being incorporated into later production lines (such as corrugated cardboard manufacturing machines), especially where continuous post-printing production steps are being carried out. That is because the pauses in the printing process will present a need also to pause the post-printing production steps. This is therefore one of the reasons that the rapid-printing rotary screen printing equipment will typically stand separate from any post-printing sheet processing production line equipment. Further, the screen printing equipment will also tend to be occurring on multiple printing machines, rather than just the one, with each printing machine performing their own print runs (i.e. sets of sequential print runs), with the resulting printed rolls then being set aside ready for later use by the sheet processing production line equipment, as and when needed. (With such stock being maintained, the effect of the printing machine downtime is avoided or minimized). The down side, however, is the added cost of equipment that results, both in terms of the financial cost of needing the multiple printing machines and in terms of the cost of the extra floorspace requirements.

Dust from the post-print processing steps is another cause of difficulty in incorporating rotary screen print equipment into the production line equipment—the dust arises since the post-print processing steps involve cutting the print receiving medium, often in many places per printed image. That dust tends to settle on the large printing surfaces of the rollers, whereby printing errors can frequently occur. For this reason, the rotary screen print equipment is typically contained in a separate room or area than the post-printing sheet processing equipment.

It would therefore be desirable to develop an alternative printing system whereby the printing equipment can be efficiently combined or incorporated into a sheet processing production line. This would then provide floorspace savings, reduced equipment downtimes, or shorter stock-storage periods, and therefore faster product production times, and also potential equipment cost savings compared to the current systems in use today.

### GENERAL DESCRIPTION

According to a first aspect of the present disclosure, therefore, there is provided a sheet processing apparatus that is adapted to receive or comprise at least one sheet input roll, and a substantially continuous sheet of material fed therefrom, the apparatus comprising sheet processing equipment for processing the sheet after it has been unrolled off the input roll and at least one digital printer adapted to print a surface of the substantially continuous sheet within the sheet processing apparatus.

Preferably the present disclosure provides a sheet processing apparatus comprising sheet handling equipment for feeding the sheet therethrough, and receiving equipment to handle or process the sheet further, post printing.

Preferably the at least one digital printer is arranged to extend across at least part of the width of the sheet to print images thereon.

Preferably the digital printer has a control process that enables the printing of different jobs on a single sheet

Preferably, the sheet is fed through or past the printer in a planar arrangement, the receiving equipment comprises sheet processing equipment for folding, cutting or otherwise processing the sheet or sheets out of the plane of the sheet so as to alter the shape and dimensions of the sheet.

Preferably the sheet processing apparatus comprises a cross-cut cutting apparatus for cutting across the substantially continuous sheet to form distinct stackable units.

Preferably, the sheet processing apparatus is in the form of a corrugated cardboard manufacturing apparatus into which three or more substantially continuous sheets of material can be fed simultaneously from a corresponding number of input rolls, the manufacturing apparatus comprising a corrugator by means of which those three or more sheets of material can be combined and formed into a sheet of corrugated cardboard.

Preferably the corrugated cardboard exiting the manufacturing line has the printed sheet on an outer surface thereof.

According to a second aspect of the present disclosure there is provided a corrugated cardboard manufacturing apparatus into which three or more substantially continuous sheets of material can be fed simultaneously from a corresponding number of input rolls, the manufacturing apparatus comprising a corrugator by means of which those three or more sheets of material can be combined and formed into a sheet of corrugated cardboard, the apparatus being characterized in that it further comprises a digital printer adapted to print at least part way across the width of one of the sheets of material, whereby the corrugated cardboard exiting the manufacturing line can have been printed on an outer surface thereof by the digital printer.

Preferably the three sheets of material are each at least 2 m wide. Further, regardless of the number of sheet rolls used, it is preferable that each is at least 2 m wide.

Preferably, during normal use of the disclosure, three sheets of material are arranged to travel through the manufacturing line at average speeds of up to and in excess of 100 mpm, and more preferably at average speeds of more than 200 mpm, or speeds of about 300 mpm.

Preferably the disclosure comprises one or more cross-cut apparatus adapted to cut the product that exits the manufacturing apparatus into predetermined lengths. Those lengths of product can form separate, distinct, sheets of corrugated cardboard, or distinct stackable units. The cutting process therefore makes the product, e.g. the exiting cardboard, more readily stackable.

The predetermined lengths are preferably presettable, or changeable, to allow the lengths to be set to suit the printed image(s) provided by the printer or printers. For example, the predetermined length may be set so as to be appropriate for the printed image on a given sheet—since the printing occurs prior to the cutting, the desired length of the sheet (i.e. the length defined by the cross-cut) will be predetermined from the known size of the image, i.e. the length of the image, plus any required margin dimensions.

Preferably the disclosure comprises one or more in-line cutting apparatus adapted to cut the product, e.g. corrugated cardboard, that exits the manufacturing apparatus along its length. This allows the exiting product to be cut into two or more pieces, each having predetermined widths. This can occur in conjunction with a cross-cut as defined above, and usually before that cross-cut.

The predetermined widths are preferably presettable, or changeable, to allow the widths to be set to suit the printed images provided by the printer(s). For example, the predetermined widths may be set so as to be appropriate for the printed images—since the printing occurs prior to the cutting, the desired width of each strip of product will be predetermined from the known size of the images, i.e. the width or widths of the images, plus any required margin dimensions.

Additional cutting blades or cutting apparatus may be also provided to trim waste off the product, or off the lengths thereof, or off the distinct stackable units.

Any or each of a) scoring equipment, b) perforating equipment or c) folding equipment may also be provided on the apparatus.

The preferred apparatus is a corrugated cardboard manufacturing apparatus. The present disclosure's digital printer, however, may also be incorporated into other high-speed sheet processing equipment, such as carrier bag production lines or processing equipment for other sheet forms of paper, plastics and cardboard (corrugated or not, i.e. including solid board processing equipment, as used for making, or for forming blanks for making, items such as washing powder boxes or cereal boxes). The apparatus may, for example, be used to unroll a sheet from an input roll, then print onto the sheet, before then using further receiving equipment to roll the sheet back into a new, now printed, roll—an output or printed roll.

According to a third aspect of the present disclosure, there is provided a sheet processing apparatus that is adapted to receive or comprise at least one sheet input roll, and a substantially continuous, substantially planar (i.e. flat across its width), sheet of material fed therefrom, the apparatus comprising sheet processing equipment for folding, cutting or otherwise processing the sheet out of the plane of the sheet so as to alter the shape and dimensions of the sheet after it has been unrolled off the input roll, and a cross-cut cutting apparatus for cutting across the substantially continuous sheet to form distinct stackable units, characterized in that the apparatus further comprises at least one digital printer adapted to print a surface of the substantially continuous sheet within the sheet processing apparatus so as to provide a printed image on an outer surface of the distinct stackable units.

Preferably this sheet processing apparatus comprises a corrugator for corrugating at least one web of sheet material as it passes through the sheet processing apparatus.

For any aspect of the invention, more than one corrugator may be provided for providing a multi wall corrugated sheet.

Features of each aspect of the invention may also be present on the apparatus of any of the other aspects of the disclosure.

The apparatus of any aspect of the disclosure may comprise laminating equipment, e.g. for laminating a cover sheet onto a backing sheet, preferably with the cover sheet being the sheet that is printed upon by the digital printer.

The lengths of product, e.g. cardboard, or the distinct stackable units, may exit their respective apparatus as unfinished blanks ready for final finishing steps in subsequent sheet processing equipment, i.e. subsequent trimming, scoring, folding and gluing (or stapling) steps.

By using a digital printer, rather than a separate rotary screen printing apparatus, printed images can be seamlessly changed from one image to the next, and they can also more easily vary across the width of the digital printer. In particular, the use of a digital printer allows consecutive (or simultaneous) print runs to be achievable without pauses between them, whereby the sheet processing steps can be carried out substantially continuously on sequential print runs and also on more than one print run simultaneously, and without significant base-material wastage due to splicing processes (in the prior art, sequential print runs can be spliced together by feeding a subsequent job into the equipment as a preceding job is being finished, although this entails material wastage due to the change-over process, and also considerable operator-machine interaction at the appropriate time).

Preferably the or each substantially continuous sheet is made of craft paper. Different sheet materials, however, can be mixed together as desired for forming the desired final product. For example, a top sheet may be a different material to a base sheet, or the corrugated layer may be different to top and bottom layers. Controlling the materials for the layers enables the material properties of the finished article to be controlled.

The digital printer might be arranged or positioned to print on an underside of a sheet within the apparatus (e.g. either a lower sheet or wall of the finished article—the cardboard length or the stackable unit, or a lower surface of a given continuous sheet therein). Preferably, however, the digital printer is arranged or positioned to print on an upper wall of a sheet within the apparatus.

More than one printer might be provided, e.g. one for printing an upper wall of a sheet within the apparatus, and the other for printing a lower wall, or underside, of a sheet within the apparatus.

A digital printer may be provided for printing the sheet prior to joining or laminating that sheet onto a lower sheet, or onto a corrugated cardboard sheet.

A digital printer may be provided within a or the corrugator within the apparatus for printing images onto a top (or bottom, if preferred) sheet of the cardboard prior to a final gluing/pinch-roller process thereof. The sheet receiving the printed image will then be flat at the time of printing, rather than rippled (as typically occurs following the final gluing/pinch-roller process.

A digital printer may be provided for printing onto the separate lengths, or onto the discrete stackable units, i.e. the printing process can occur after a first cutting process. This is less preferred, however, since the cutting process typically generates dust (or paper swarf), which can interfere with the reliable operation of the printer.

By providing the digital printers, the material used to form the top sheet of the product can directly be printed upon, rather than requiring an additional pre-printed cover sheet to be used (such as the sheet formed by the rotary screen printing machine). The material cost of the cardboard can therefore be reduced—potentially by a quarter (three sheets, rather than four). However, it is also possible to retain the extra sheet—providing a white paper covering from an output roll, which white paper covering gets laminated onto the top sheet of the cardboard, in the manner shown schematically in FIG. 2. This gives increased freedom as to where to locate the digital printer—it can be located upstream of the rolls used for forming the corrugated cardboard. Further, the additional layer can offer an improved finish to the finished article.

It would be desirable to provide the digital printer such that it extends as a single unit across the full width of the continuous sheet(s) passing through the sheet processing apparatus. However, sufficiently high speed digital printers for printing web widths greater than 700 mm, while still maintaining sheet feed speeds of 200 mpm, are not currently commercially available. Therefore, for wider widths, individual printers might not extend across the full width, or else the sheet feed speeds are slower. For maintaining higher speeds, however, a plurality of digital printers can be provided across the width of the apparatus, e.g. two or more.

According to a fourth aspect of the present disclosure, which may likewise have common features to those of the first to third aspects, and vice versa, there may be provided a sheet processing apparatus comprising sheet feeding equipment for feeding at least one continuous web of sheet material therein or therethrough, and at least two digital printers each arranged to extend across at least part of the width of the web. The printers may be arranged in an aligned manner such that they lie end to end, or they may be arranged in parallel to one another, but displaced out of line of one another, potentially with overlapping ends—there will then be either a reduced, or no, portion therebetween on which neither printer can print.

The use of two digital printers, arranged substantially end-to-end (be that in an aligned form, or in a relatively displaced form, as discussed above) allows substantially the full width of the web, or even the entire width, to be printed upon, even though each printer alone cannot achieve that.

Preferably the apparatus is adapted to receive two or more webs of sheet material therethrough, the printer being adapted to print upon one of them.

The apparatus may comprise sheet processing equipment for processing at least one of the webs of sheet material into a non-flat condition, such as a corrugated condition.

It is desirable to print predetermined images across the full width of the web that receives the printed images. As a result of this there has always been a perceived difficulty with the use of two or more digital printers arranged like this—printed imagery in the middle (or overlap area) between two digital printers cannot be maintained in a perfectly aligned condition, whereby there will inevitably be print inaccuracies in that region. For this reason, skilled persons have not produced such an arrangement within a sheet processing apparatus, even though high speed printers have been known for some time. The present inventor(s), however, has realized that the problem does not actually manifest itself in many circumstances—it is rare for a printed image to be wider than the width of existing high speed printers, whereby multiple printers, running side by side, can be used across the width of a continuous web for producing the images required on that web for almost every print job required. The provision of such an apparatus would therefore be advantageous, contrary to existing preconceptions.

Preferably each printer has a print width of at least 624 mm. More preferably each printer has a print width of at least 762 mm (30 inches). More preferably each printer has a print width of at least 1066 mm (42 inches).

Preferably the web feed speed is at least 100 mpm, or is more preferably at least 180 mpm, 200 mpm or 300 mpm.

This multi-printer arrangement is particularly useful for web widths of in excess of 2m.

It is possible for more than two digital printers to be provided, e.g. 3 printers on a web width of 2.4 m or even 2.8 m.

This arrangement of the present disclosure provides significant advantages in terms of cost and production rates/time compared to the prior art arrangements using rotary screen printers. That is because each digital printer can provide its own print run output, whereby two or more separate print run outputs can be run side by side, and further the print runs can be done without the need for the production of dedicated screen print rollers (which are themselves highly costly).

Further, high speed output is continuously achievable directly onto blank, or non-printed, print receiving medium, whereby there is no need to produce or store pre printed rolls of coversheet material.

Suitable high speed printing units are already available from Hewlett Packard—the T300 color inkjet web press, or the T400 color inkjet web press, or from Kodak—the Prosper 5000 XL color inkjet web press. It is anticipated, however, that newer, wider printers will be produced commercially in the future, thus enabling fewer printers to be provided for a given web width, or enabling a wider web width to be accommodated by the commercially available printers.

In addition to the ability to print different jobs side by side, digital printers allow multiple colors to be printed at these high speeds and for a print run to have continuously (sequentially) varying detail(s) thereon, such as serial numbers for uniquely identifying each printed product. Screen print rollers typically need to print the same image repetitively, thereby making it difficult to provide serial numbers on the printed image.

Preferably the individual printer or printers is/are mounted on moveable carriage(s), whereby they can be moved across the width of the web. Often no movement is needed, and for two printers, one may print one side of the web (e.g. the left side), and the other may print the other (adjacent) side of the web (e.g. the right side). They can print the same image, for running a single print run, or they can print different images, for printing two print jobs simultaneously. However, by having them moveable, their positions can be adjusted relative to the web for optimizing print coverage across the paper. For example, a wide unprinted margin may be required, whereby moving the printer away from the edge, to provide that margin, allows the printer to produce a repeating image that exceeds the width of the printer—(the repeating image will be the printed image plus any required margins, and it could even be a combination of multiple different print jobs, each with their own margins).

The web can also be moveable relative to the printers. This is already achievable for moving the web relative to guide rollers, rather than the printer per se, and it can offer added benefits in terms of speed of job-change where print positions need to change (moving the printer is likely to be slower than moving the web).

According to a fifth aspect of the present disclosure there is provided a roll comprising a rolled sheet of material, the roll having a diameter of at least 300 mm and a width of at least 1 m, and the rolled sheet having extending along a substantial part of its length, on at least one surface thereof, a plurality of different printed images, each printed image, or at least the majority thereof, having a length of at least 300 mm and being destined for providing a printed covering of a predetermined product.

Preferably the diameter is at least 500 mm, or even at least 1 m.

Preferably the width is at least 1.4 m wide or about 2 m wide or even about 2.4 m wide.

Preferably adjacent but different, printed images have a maximum spacial separation (period) corresponding to no more than 10 image lengths (and more preferably no more than 5 image lengths or 2 image lengths).

In an alternative arrangement, the spacial separation may be set according to the timing, and/or distance travelled by the sheet in a given printing time period. For example, that spacial separation is preferably no more than the sheet transit distance that occurs within the printing machine used during a period of 10 seconds, and more preferably a period of 5 seconds or 2 seconds.

In a further alternative arrangement, the spacial separation may be set according to the printing speed of the printer that produces the printed sheet. For example, for a printer with printing speeds of 100 mpm, 1.66 m of image can be printed every second. Preferably, therefore, blank space between differing consecutive images does not exceed 10 m, or more preferably 5 or 3 m. For faster print speeds, such as 300 mpm, preferably blank space does not exceed 30 m, or more preferably 15 or 9 m.

These spacial separations from one print job to the next (the different printed images) are significantly smaller than those that have been considered previously for use in a continuous sheet processing machine such as a corrugator. That is because the printing technology commonly used (rotary screen printing) could not achieve job switching mid-roll, even though the corrugating machines could adapt their cutting, creasing and perforating (and in some instances folding) units mid-roll, and relatively quickly, e.g. in 2, 5 or 10 seconds, depending upon the changes required (e.g. to the cutting or creasing or perforating widths and lengths). After all, some of these changes are just dependent upon the control instruction varying the timing of such cutting, perforating, creasing or folding steps or switching over to alternative cutting, perforating, creasing or folding units in the assembly line. The present invention would therefore enable jobs to be switched much more quickly, and with minimal or zero down-time or web wastage, thus making changes to jobs mid roll a real, commercial, possibility.

It is also envisaged that it could take a mere matter of hours between receiving instructions for a job and commencing printing, and perhaps cutting, folding, perforating and creasing of the final blank, since the printer can have a print-run inserted into its queue, with that print-run being likewise appropriately indexed into the sheet processing apparatus' cutting, folding, perforating and creasing units' control program. Before the present disclosure, however, the time-delay between receiving the order and processing the job is typically days since the printed sheet had to be printed separately onto a dedicated roll of material, and before that, dedicated screen-print rollers had to be produced.

The present disclosure's enabling of job variations within a roll will make smaller jobs much more economical as there would be no need for a whole roll (and screen-print roller) to be devoted to a single job.

Additionally, manufacturers will be able to increase the variety of designs, e.g. for the packaging of their products, without significantly increasing overheads, as a number of designs could all be printed on a single roll with minimal additional cost.

Preferably, the different printed images are of varying job length. The use of digital printers means that the length of a job is of little significance, and so job lengths can vary virtually indefinitely.

In addition to controlling the printer, a smart control system can be provided for allowing modifications to knife/perforator/creasing units' timings so that they can be changed according to job length, ensuring that such jobs are cut accurately as the jobs switch from one image to the next.

In some arrangements, the job order of the images fed to the printer(s) for printing the images onto the roll is the desired job output order reversed. This is ideal for apparatus designed to print and then re-roll the sheet since the last image printed will be the first image unrolled. In-line printing within a corrugator, however, produces the products in the order in which they are printed.

Preferably, the sheet, the roll or the web has a width for receiving printed images that is at least 2 m wide.

According to a sixth aspect of the present disclosure there is provided a method of providing printed product, the product having one or more printed image thereon, comprising providing an apparatus as described above, and printing images onto the substantially continuous sheet within the apparatus using the digital printer.

Printing can occur anywhere within the apparatus and may occur on either or both sides of the web, i.e. on the top and/or the bottom thereof.

Preferably, the printing occurs prior to trimming or cutting the product from the web, e.g. to a stackable unit size.

The method of the present disclosure facilitates faster printing-to-product speeds as a continuous sheet can be fed through the printer, and then processed in that same apparatus into a product such as a cut-out blank. This serves to avoid or reduce the handling complexity associated with handling a large number of discrete jobs at high speed.

Preferably, sequential print jobs are printed with less than 10 second pauses (gaps) between them. More preferably, sequential print jobs have less than a 5, 2 or 1 second pause between them. Smaller pauses result in more efficient and economic printing lines. However, in certain situations increased pauses may be selectively desirable, e.g. to facilitate complex knife-layout changes. Given the advance knowledge of the consecutive images to be printed, and the resulting knife/fold/perforation/crease/corrugation requirements, print pauses can be appropriately predetermined as well.

Preferably, more than one print job is printed at the same time within the apparatus, the print jobs being printed side by side. This is possible as rarely does a single job require the full width of a roll.

With current digital printer technology, this side-by-side printing can be achieved in full width webs (e.g. 2.4 m webs) by using two parallel-arranged printers, e.g. located end to end or slightly offset and overlapping. However, in the future it is anticipated that printers with greater widths will be available, and then these simultaneous printing jobs could be undertaken by a single, full-width printer.

Full width printing is already achievable for 1 m webs using an appropriate high speed printer such as the Hewlett Packard T400 printer.

The use of digital printers enable consecutive jobs to be changed almost instantly, therefore not affecting the neighboring job.

The use of integrated, control systems for the knives/perforators/creasers etch, i.e. ones inked with the printing instructions so as to appropriately time any change-overs between jobs, will also mean that individual job lengths, plus cutting/folding/creasing etc requirements may also vary during printing without affecting the other job. Double knife arrangements (or triple knife arrangements if three images are arranged side by side) are useable in this regard such that each printed image is processed separately.

Preferably, the web has a feed speed of at least 100 mpm. More preferably the speed is in excess of 200 mpm or even 300 mpm. Faster speeds result in more time-economic printing. However, the wider single print bars are currently only available for slower speeds. The Hewlett Packard T400, for example, prints at a speed of up to 122 mpm (400 feet per minute), although it is envisaged that as technology develops both the size and speed of print bars will increase.

Preferably, two or more separate print runs are run side by side. Further, preferably the products are cardboard blanks.

Preferably, the products are cardboard boxes in a substantially unassembled state.

The disclosure further provides a corrugated cardboard manufacturing apparatus into which three or more substantially continuous sheets of material can be fed simultaneously from a corresponding number of input rolls, the manufacturing apparatus comprising a corrugator by means of which those three or more sheets of material can be combined and formed into a sheet of corrugated cardboard, the apparatus being characterized in that it further comprises a digital printer adapted to print at least part way across the width of one of the sheets of material, whereby the corrugated cardboard exiting the manufacturing line can have been printed on an outer surface thereof by the digital printer.

The apparatus above, comprising one or more cross-cut apparatus adapted to cut the corrugated cardboard that exits the manufacturing apparatus into predetermined lengths that define stackable units.

Additionally, optionally comprising one or more in-line cutting apparatus adapted to cut the corrugated cardboard that exits the manufacturing apparatus along its length.

Preferably comprising a plurality of cutting blades or cutting apparatus to trim waste off the cardboard.

Still further, the disclosure provides a sheet processing apparatus that is adapted to receive or comprise at least one sheet input roll, and a substantially continuous, substantially planar, sheet of material fed therefrom, the apparatus comprising sheet processing equipment for folding, cutting or otherwise processing the sheet out of the plane of the sheet so as to alter the shape and dimensions of the sheet after it has been unrolled off the input roll, and a cross-cut cutting apparatus for cutting across the substantially continuous sheet to form distinct stackable units, characterized in that the apparatus further comprises at least one digital printer adapted to print a surface of the substantially continuous sheet within the sheet processing apparatus so as to provide a printed image on an outer surface of the distinct stackable units.

The sheet processing apparatus, comprising a corrugator for corrugating at least one web of sheet material as it passes through the sheet processing apparatus.

The sheet processing apparatus, comprising more than one corrugator for providing a multi wall corrugated sheet.

The sheet processing apparatus, further comprising laminating equipment for laminating a cover sheet onto a backing sheet, the cover sheet being a sheet that is printed upon by the digital printer.

An apparatus as described anywhere above, further comprising more than one printer.

Preferably, at least one printer is provided for printing on an upper side of a web that will form, or that has been used to form, an upper wall of a printed article exiting the apparatus, and at least one other printer is for printing a lower wall, or underside, of a web that will form, or that has been used to form, a lower wall of a printed article exiting the apparatus.

An apparatus, wherein at least two printers are provided for printing across the width of a web.

An apparatus as described anywhere above, wherein the or each web for receiving printed images is at least 2 m wide, and two or more printers are positioned in the apparatus for printing on that web, neither individual printer extending across the full width of the web.

A sheet processing apparatus comprising sheet feeding equipment for feeding at least one continuous web of sheet material therethrough, and at least two digital printers each arranged to extend across at least part of the width of the web.

An apparatus as described anywhere above, comprising two or more digital printers arranged parallel to one another, but displaced out of line of one another.

An apparatus as described anywhere above, wherein the or each digital printer is arranged on a moveable carriage to allow the printer to be moved relative to the web onto which the printer is adapted to print.

An apparatus as described anywhere above, wherein the web is adapted to be moveable laterally within the apparatus, relative to the or each printer.

A method of providing printed sheet products, the products having printed images thereon, comprising providing an apparatus according to any one of the preceding claims, and printing the images onto a web within the apparatus using the digital printer.

The method described above, wherein the printing occurs prior to trimming or cutting the products to a stackable unit size.

The method described above, wherein sequential print jobs are printed with less than 10 second pauses between them.

The method described above, wherein more than one print job is printed at the same time within the apparatus, the print jobs being printed side by side.

The method described above, wherein the web has a feed speed of at least 100 mpm.

The method described above, wherein two or more separate print runs are run side by side.

The method described above, wherein the products are cardboard blanks.

The method described above, wherein the products are cardboard boxes in a substantially unassembled state.

These and other features of the present invention, each of which are interchangeable between the various aspects of the present invention, will now be described in greater detail with reference to the accompanying drawings in which:

### BRIEF DESCRIPTION OF THE DRAWINGS

FIG. 1 shows a prior art rotary screen printing process;

FIG. 2 shows a sheet processing apparatus in the form of a corrugated cardboard making machine, showing the prior art arrangement, and potential modifications thereto to bring it in line with the various aspects of the present disclosure;

FIG. 3 shows a typical output of the screen printing machine of FIG. 1;

FIG. 4 shows a possible output from a digital printer that extend across a web;

FIG. 5 shows a further possible output from a digital printer in which various mixtures of print jobs are continuously produced out of the printer;

FIG. 6 shows an arrangement in which two digital printers are provided;

FIG. 7 shows a modification to the corrugated cardboard making machine of FIG. 2 in which the web is cut into separate webs for separate downstream processing into stackable sheets.

### DETAILED DESCRIPTION

As suggested above, the present disclosure concerns an apparatus from which a product exits at high speed or high frequency, which product features a printed surface, and generally a wide-width format. High speed typically encompasses speeds of over 100 mpm, and wide widths generally encompass widths of over 600 mm, or even over 1 m, or over 1.5 m.

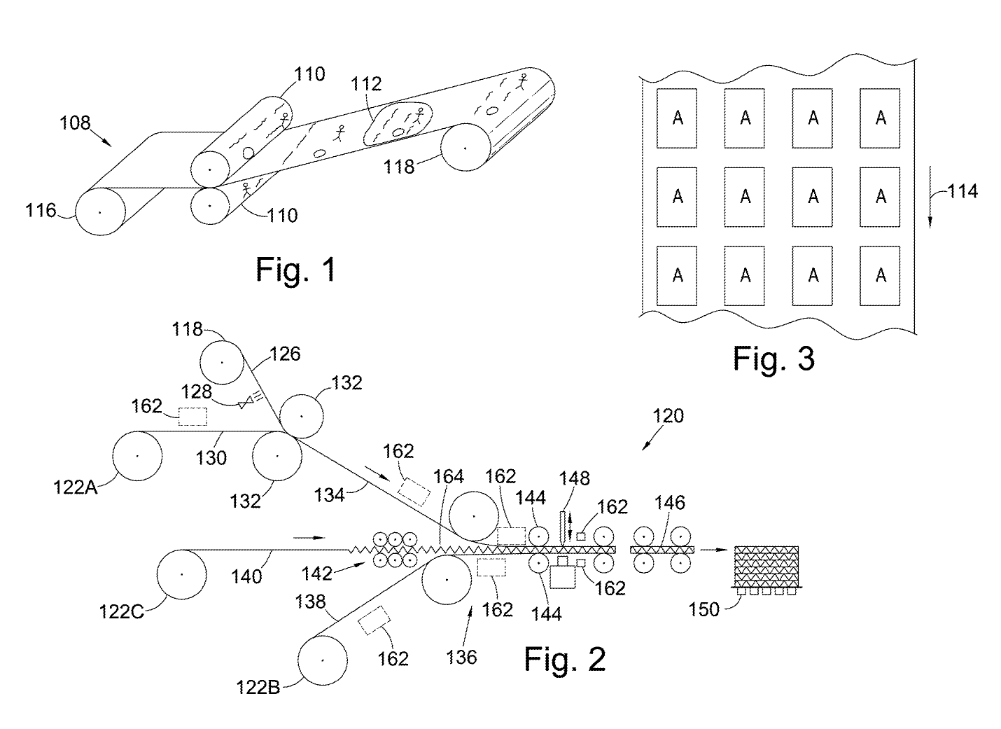

Machines for forming such products are well known, but they have always used a different printing process to that required by the present disclosure. This has been necessary due to the high speed/wide width outputs, and the need for the printing process to match or exceed those requirements. Therefore, the prior art apparatuses for producing products with a printed surface have typically used separate rotary screen printing machine 108 to pre-form images 112 onto webs (see FIG. 1), and then a laminating process (FIG. 2) for joining the printed webs 126 to the surfaces of the products either before or after producing the products 146. This is the standard practice in corrugated cardboard product processing equipment 120.

Other systems for other products (usually narrower products), have used an offset printing press, e.g. for newspapers, due to the very high speeds that are achievable (more than 60,000 newspapers per hour, and web speeds of over 600 mpm) or various forms of flexographic printing, e.g. for carrier bags.

The present disclosure, however, instead requires the use of in-line digital printers 162.

Referring now to FIG. 2, a typical product manufacturing line is schematically illustrated. It takes the form of a corrugated cardboard making machine, or a sheet processing apparatus 120.

In this apparatus 118, when set up as known in the prior art, the features shown in dotted lines will not be present. In that prior art arrangement, for a simple printed corrugated cardboard sheet, four webs 126, 130, 140, 138. The uppermost of those, in this example, is pre-printed web 126, and it is unraveled off an output roll 118 that has previously been processed by a rotary screen printing machine 108, such as that shown schematically in FIG. 1.

The cardboard making machine 120 then includes three lower webs 130, 140, 138, each being unraveled off its own respective roll 122A, 122B, 122C.

Being ultimately for forming corrugated cardboard, it is generally the case that these four rolls will all be in the form of paper, and usually kraft paper.

The three lower webs are arranged in the machine 120 such that an uppermost one 130 forms an upper wall of the corrugated cardboard structure, a lowermost one 138 forms a lower wall of the corrugated cardboard structure and a middle web 140 forms the corrugated core 164 of the corrugated cardboard structure. The web 126 from the output roll 118 instead just provides an upper facing for the upper wall of the corrugated cardboard structure.

To laminate or attach that upper facing to the uppermost web 130 of the corrugated cardboard structure, numerous approaches can be taken, but a typical one, as shown, involves spraying glue to an underside of the pre-printed web 126, as it unrolls off the output roll 118, using a glue sprayer 128, and then that pre-printed web 126 can be laminated or adhered onto the upper surface of the uppermost web 130 as the two webs 126, 130 are fed through a pair of pinch rollers 132.

That pre-laminated top wall 134 can then be fed down to a corrugator 136, which joins the three lower webs together in a known manner—the middle web 140 and the lowermost web 138 have meanwhile been feed downstream also towards the corrugator 136 as they unrolls off their respective rolls 122B, 122C. The middle web, however, will additionally be passed through a folding apparatus to form corrugations there in, e.g. using corrugating rollers 142. Further, those corrugating rollers 142 may be associated with further glue applying means for applying glue to the peaks of the corrugations, whereupon the three remaining webs 134, 140 138 can be pinched together by further pinch rollers 144, thus forming the corrugated cardboard sheet.

That corrugated cardboard sheet is then cut to a predetermined length across the width of the web so as to form separate sheets or units 146, e.g. using a reciprocal blade cutter 148. prior to then stacking those units 146 on a pallet 150.

The physical arrangement of the various elements of these corrugated cardboard manufacturing machines can vary considerably over that which is shown schematically in FIG. 2. For example, it is generally the case that the machines 120 involve numerous linearly separated machines, rather than machines in which the rolls are arranged one above the other. Further, the various units, by being linearly arranged, can form a manufacturing line which may be straight or meandering. A typical straight manufacturing line will be in excess of 50m in length for corrugated cardboard manufacturing processes.

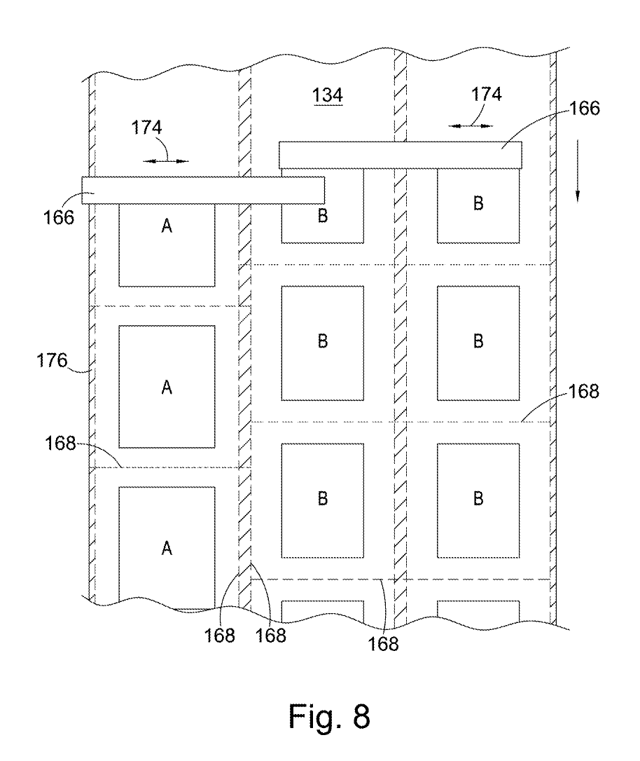

In addition to the cross-cut (or transverse cut) arrangement shown in FIG. 2, as shown in FIG. 7 it is additionally known to provide longitudinal cutting equipment, such as rotary blade cutters 152, for cutting the corrugated cardboard sheet 154 into two or more separate lines 156a, 156b (and/or for removing linear waste portions, either where present or when required). As shown this can be prior to cutting the substantially continuous web into separate sheets or units 146. Alternatively it may occur after that transverse cutting step, but prior to stacking, or even on a subsequent machine after stacking.

As shown, the rotary blade cutter 152 can be moved sideways across the width of the corrugated cardboard sheet 154 for accommodating different output requirements. This therefore allows the equipment to accommodate different jobs simultaneously within the substantially continuous web of corrugated cardboard that outputs from the machine, potentially each on a separate pallet. For example, one output line 156a may be for forming stackable units that are required to be 800 mm wide, whereas the other output line 156b may be for forming stackable units that are required to be 1.2 m wide.

Further, the longitudinal cutting may offer a preliminary trim step, whereby for example if the uncut web is 2.4 m wide, a plurality of cuts are made—potentially two edge-cuts for trimming off outermost waste, and two internal cuts for trimming out a middle section of waste. The two remaining “good” parts then can continue down their respective paths, like that shown in FIG. 7.

Additional cutters, and additional paths, can be provided too, and they can be arranged one above the other, or side by side, or one after the other along the length of the manufacturing line

In these cardboard making machines 120, the sheet feed speed is typically, on average, in the region of, or in excess of, 200 mpm. Therefore, output frequencies for the output separate sheets or units, and therefore also the reciprocation frequency of the reciprocal blade cutters 148, is often in the region of 1 to 5 Hz (1 to 5 reciprocations per second).

The present disclosure can take advantage of all of these features since they all can remain even after adding the digital printer(s) to the machine. However, the digital printer(s) can negate the need for the separate output roll from a separate printer. That is because with the digital printer(s), the relevant web can be printed directly within the machine 120. Nevertheless, pre-printed webs 126 can still be provided or used if desired, especially if background printed images are required, thereby avoiding excessive ink requirements in the digital printers (which ink is more expensive than rotary screen print ink), since there are occasions when pre-printed webs are useful (e.g. if the coversheet is to have particular surface characteristics, which surface characteristics make digital printing non-viable). Nevertheless, the ability to dispense with that separate output roll is generally advantageous since then no separate processing of the output roll 118 prior to incorporation into the cardboard making machine 120 is necessary. Further, no time intensive interruption of the printing function is needed whenever a print run is to be changed—for rotary screen printing machines, the screen print rollers have to be changes, whereas for digital printing, the image can be changed indefinitely, simply by having the relevant image processor (PC) send through a different image for printing. This therefore means that the corrugator can run continuously, and with minimal wastage, even when forming the corrugated cardboard for numerous consecutive (or even two or more simultaneous) print jobs, and that is even achieved without the need to provide complex paper splicing mechanisms for inputting consecutive printed paper sources (i.e. paper sources featuring different print jobs).

The use of digital printers, therefore, completely changes the landscape of cardboard processing equipment, making jobs quicker to turn around, making large potential savings in terms of reduced wasted time and materials, and also potentially reduced manufacturing costs per se, due to the possibility of dispensing with the pre-printed top sheet, i.e. using the standard from of upper wall of the cardboard for receiving the printed image, rather than either a separate pre-printed sheet that has to be laminated thereto, or a thicker top sheet for allowing post-printing to be carried out (a characteristic of corrugated cardboard is that the outer walls of the corrugated cardboard sheets are rarely perfectly flat, which makes them unsuitable, normally, for post-printing, so in post-printing applications, the walls on which printed imagery is destined to be received are typically formed from a heavier weight of paper, whereby a flatter surface can be ensured, thus better accepting the post-printed image).

In addition to improving cardboard manufacturing processes, the use of the digital printers will also be beneficial in other sheet processing equipment in which sheet materials are processed at high speeds, such as plastic bag manufacturing lines, and food packaging. In such machines, printed sheets (usually plastic) have to date been fed through e.g. a screen printer in a separate area to the machine that forms the plastic bags, or the food packaging, rather than in the same manufacturing line, or else the printers have been of a narrow format (less than 1 m, and usually less than 600 mm) or of a too-low a sheet feed speed (i.e. less than 100 mpm), and laso typically in single file (i.e. not multiple products across a given sheet). The digital printer arrangements of the present invention will therefore be able also to enhance those other manufacturing process, by enabling packaging or bags to be printed side by side, across a wider web of material, and at high feed speeds.

The printed effects achievable with the rotary screen printing apparatus of FIG. 1 are likewise achievable with the digital printing arrangements of the present invention. For example, referring to FIG. 3, a desired print run might comprise multiple and continuous repeats of the same image, which print run can then run until the desired number of prints are achieved. With the digital printer arrangement, however, each image might be individualized, e.g. with a serial number. This would not be readily achievable with the rotary screen printing apparatus.

Further, with the digital printer arrangement, upon completing that first print run, the printers can immediately, or nearly immediately, start to print the next print run. If the print bars, or the web, are to be moved (see below), then it is likely to be desirable to implement a brief pause in the printing process, i.e. a cessation of printing, but not necessarily a cessation of or change in the web movements. That would then also allow downsteam equipment also to have a time period for realignment or change-over to the new print job at the appropriate time. The new print job can then run its course too, for subsequent processing downstream by the corrugator and the cutting units 148, 152.

The pause in the printing, however, is not always necessary. For example, if only the image pattern changes, i.e. the desired size of the stackable units 146 remains the same, but the image 112 changes, then there is no need to input a pause in the printing. Likewise, if only a transverse cut is being deployed (see FIG. 5, print runs can change immediately—only the reciprocation frequency of the cross-cut knife 148 needs to be changed. However, where the size does change, the position of the longitudinal cutting devices 152, and the frequency of the cross-cutter 148, may both need to change. This might not be achievable at a speed that can match the image printing frequency. Therefore, having a pause will minimize print ink wastage during such a changeover. However, high speed changes may yet still be achievable anyway by having redundant cutters in situ—one set set-up for the current print run, and another set for swapping therewith for a subsequent print run—the computer can preset the required positions since it knows the shape of the next print run.

Changes to the operation of the corrugator may also need to be undertaken for consecutive print runs—different products may want different corrugation densities/wavelengths. These changes can take a few seconds to complete, so having the printing pause between print runs provides time for such changes, without wasting ink.

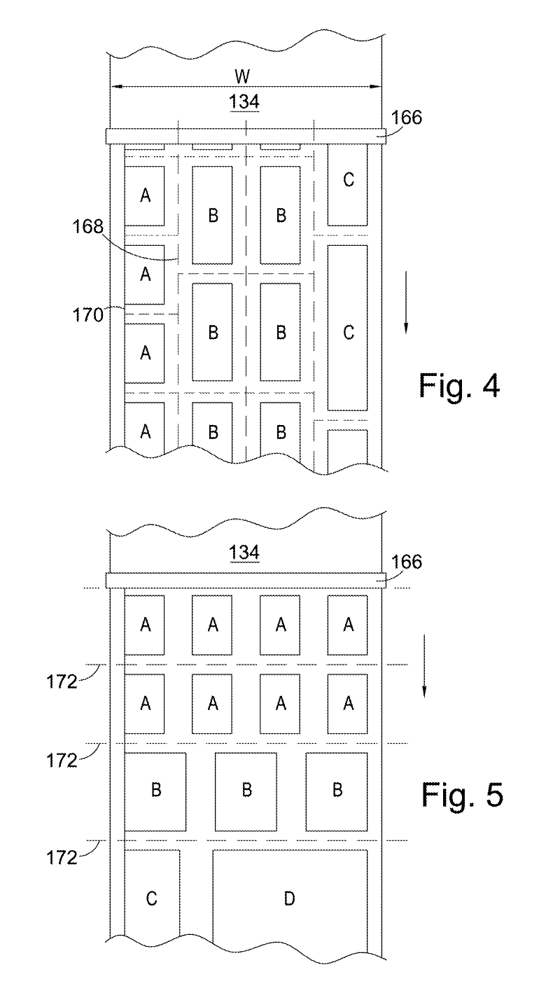

A further significant development that is achievable with the use of inline digital printers is the ability to offer increasing complexities and flexibility in the print patterns themselves. Firstly, there are effectively no restrictions on colors, since a fixed color set is not relied upon—full color printing is possible. Secondly, as previously mentioned each image can be differed (e.g. with serial numbers). Thirdly, at no additional cost it is possible to run two or more print runs at the same time, i.e. side by side. See, for example, FIGS. 4, 6 and 8. With rotary screen printing, however, dedicated screen print rollers have to be made for any given print run, or combination thereof, with the inherent costs arising therefrom. Fourthly, there is no limit to the length or linear spacing of a print pattern, whereas with rotary screen print rollers, the circumference of that roller is a limiting factor both in the possible size of a printed image and in the length/spacing of a repeating image—the images must either fit, or be arranged to be equally spread, around the circumference of the roller, the latter arrangement being to provide a consistent repeating array not just on a given singular rotation of the roller, but through sequential rolls of the roller. With the digital printer arrangement of the present invention, however, these limitations are not presented.

Another advantageous benefit of digital printing, and a cause for the ink being higher in cost, is that the ink dries very rapidly, thereby allowing in-line fitment of the digital printers—rotary screen print machines typically employ ink curing means to allow the web to be rolled up again after printing. However, if for the digital printers ink curing rollers are again needed, they can also be incorporated in-line, as appropriate. Likewise surface finishing coatings may want to be applied, and they too can be applied in line.

A further advantage is that the digital printers tend to be relatively compact, whereby they can be incorporated relatively easily into the production line, an any one of many possible locations, including near the paper source rolls 122, just prior to the corrugator, above a output roll's web 126, downstream of an initial lamination process—opposite the laminated web 134, inside the corrugator 136, or even after the corrugator 136.

Referring now specifically to FIG. 4, there can be seen four side-by-side lines of printed images. The images take the form of three separate print runs A, B, C, with the leftmost print run being print run A, the middle two print runs being both print run be, and the rightmost print run being print run C.

Between the print runs dotted lines 168 are shown. Those dotted lines represent the location of cuts to be performed further downstream on the apparatus. They are not usually printed onto the web. They are shown in the drawings for illustrative purposes only.

Down one side of the web, there is also shown a solid, continuous line 170. This line often is printed by the printer. It provides a reference line for indexing further down the apparatus. The longitudinal cutting units 152 can be indexed off that solid, continuous line. Additional solid continuous lines might also be provided elsewhere on the web, again for the same purpose, for where the web is split (as in FIG. 7). This would facilitate further longitudinal cuts to be performed by subsequent cutting units, if required.

The solid continuous line 170 may also feature marks for indicating where the transverse cuts are to be performed. Those marks could then be as index marks for the crosscut blades 148, be that for a single crosscut unit, or multiple separate crosscut units (in which case the second continuous lines mentioned in the preceding paragraph would be beneficially present).

The four print runs A, B, C are printed using a single print bar 166, which extends across the full width W of a substantially continuous web 134. By being a single print bar 166, typically no movements of the print bar relative to the web 134 will be required. Typically this arrangement will be limited to applications where the web has a maximum width of perhaps 1 m. However, as wider print bars are produced by manufacturers, the width of the web can be widened to.

To accommodate wider webs, the print bar can be mounted on a carriage for being movable relative to the web, or the web may be movable on its rollers for movement relative to the print bar. The movement allows jobs with different waste margins to be accommodated, where those waste margins extend away from the edges of the print bar. This is further explained in relation to FIG. 8, in which two print bars are provided, each mounted on a movable carriage.

Referring next to FIG. 5, again a substantially continuous web 134 is shown. Further, a single print bar 166 is shown which extends across the full width of the web 134. This printer arrangement, have, instead has the separate jobs A, B, C, D organized onto the web in batches which group across the width of the web. This allows singular transverse cuts 172 to be used for separating the substantially continuous web into stackable units. Although only a single line of images B are shown, this image is a schematic and it is more probable that many hundreds of such images B would be presented sequentially.

Images C and D are shown arranged side-by-side. This is illustrative of the flexibility provided by the digital print bar.

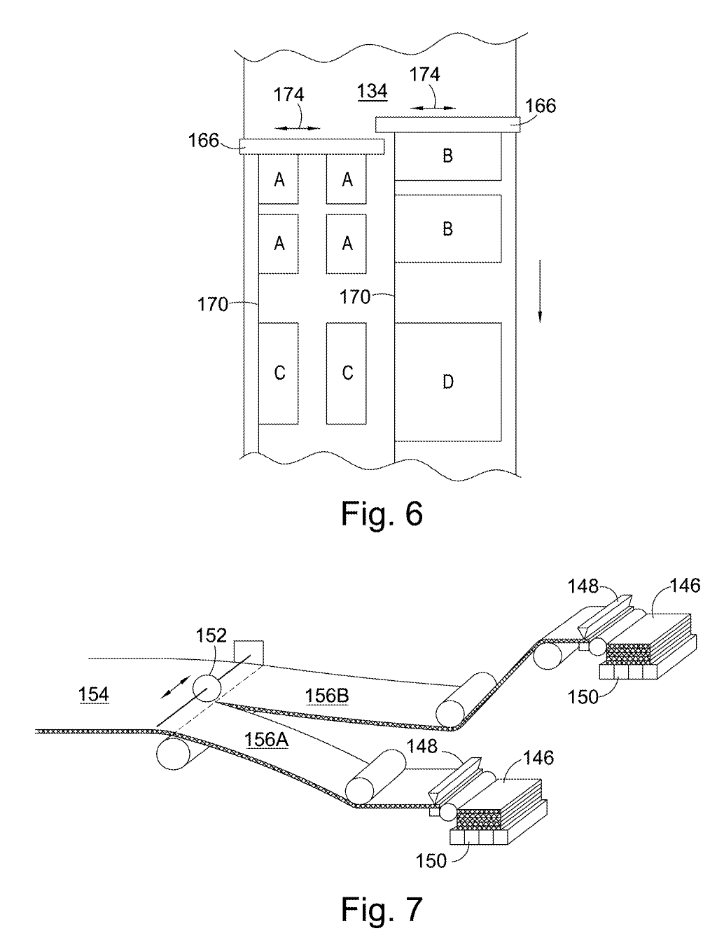

Referring next FIG. 6, a further substantially continuous web 134 is shown. Further, print jobs A, B, C, D are shown being printed by a digital printer arrangement. Here, however, there are two digital printers arranged substantially side-by-side across the full width of the web 134. Each digital printer illustrated is fractionally wider than half the width of the web. For example, for a 2 m web, to HV T 400 color inkjet web press printers may be provided, each being 42 inches wide and capable of printing 180 mpm.

In this arrangement, each printer 166 is mounted upon a carriage (not shown) to allow it to traverse 174 at least partially across the width of the web 134. This ability to traverse offers no function in the print jobs illustrated in FIG. 6, since each combination of print jobs being printed by each respective printer 166 is adequately accommodated by the printer 166N its fixed default position illustrated. Therefore, the left-hand printer 166 has printed print job C in two lines of side-by-side images and is currently printing print job A also in two lines of side-by-side images. The right-hand side printer, however, is printing a larger image run B, and has already completed an area print run D.

Again the solid continuous line 170 is shown for allowing indexing of a cutting arrangement further down the system. This figure addition shows a second solid continuous time and 70 printed by the second printer 166. The second indexing line is recommended to be provided where two printers are running together since each printer may not be perfectly indexed relative to the other printer, whereby an indexing line provided by one printer might not be perfectly aligned for the print run generated on the second printer.

Finally, referring to FIG. 8 a further arrangement are shown which further illustrates the flexibility of the present invention's digital printer arrangement, and specifically the use of two digital printers, each mounted on a carriage for transverse movement relative to the web. Please bear in mind that some of the movements may be more beneficially achieved by moving the web relative to the rollers over which the web passes, since that can be achieved very rapidly, where as movement of the printers may need to be done more slowly since the printers are less robust. However, it is frequently the case that one printer needs to be moved relative to the other printer, whereby movement of the printers themselves becomes necessary.

As shown in FIG. 8, two print runs A, B are being run at the same time, one by a left-hand print bar 166 and the second by the right-hand print bar 166. The first print bar 166 is printing a single print run having an image A, but with predefined waste edges 176 that will be cut away by longitudinal cutters 152 (see FIG. 7—although only a single cutter 152 shown in figure). Around the image A, however, unprinted portions will survive the stackable unit forming step, which unprinted portions will be required, at least in part, in the finished blank produced by the corrugated cardboard manufacturing machine 120. The stackable unit 146 is therefore defined not by the image, but by the dotted lines 168, which lines include both longitudinal cuts and transverse cuts.

The right-hand print bar 166, however, is printing two images, each defining a part of a further stackable unit 146. Those stucco units also have unprinted portions around the edges of the image B. In this case, however, the single print by one success can print two images B in appropriately spaced relation to one another, but cannot extend fully across the full width of two stackable units. Further, had the printer 166 been positioned at the edge of the web 134, as per the left-hand printer 166, the printer 166 would not have been able to print both images.

Therefore, by traversing more towards the middle of the web 134, the printer is enabled to print both images B.

Then, once printed, the web continues to the subsequent processing equipment whereat the waste 176 is cut away from the stackable units to form the stackable units 146.

The present invention has therefore been described above purely by way of example. Modifications in detail may be made to the disclosure within the scope of the claims appended hereto.

1. A sheet processing apparatus that is adapted to receive or comprise at least one sheet input roll, and a substantially continuous sheet of material fed therefrom, the apparatus comprising sheet processing equipment for processing the sheet after it has been unrolled off the input roll and at least one digital printer adapted to print a surface of the substantially continuous sheet within the sheet processing apparatus.

2. A sheet processing apparatus according to claim 1, the sheet processing equipment being for folding, cutting or otherwise processing the sheet or sheets out of a plane of the sheet so as to alter the shape and dimensions of the sheet.

3. A sheet processing apparatus according to claim 1, being in the form of a corrugated cardboard manufacturing apparatus into which three or more substantially continuous sheets of material can be fed simultaneously from a corresponding number of input rolls, the manufacturing apparatus comprising a corrugator by means of which those three or more sheets of material can be combined and formed into a sheet of corrugated cardboard, and wherein the corrugated cardboard exiting the manufacturing line has parts of the printed sheet on an outer surface thereof.

4. A sheet processing apparatus according to claim 1, comprising one or more cross-cut apparatus each adapted to cut at least part way across the width of the sheet so as to form predetermined lengths that define stackable units.

5. A sheet processing apparatus according to claim 1, comprising one or more in-line cutting apparatus adapted to cut the sheet along its length.

6. A sheet processing apparatus according to claim 1, comprising a plurality of cutting blades or cutting apparatus to trim waste off the sheet.

7. A sheet processing apparatus according to claim 1 comprising a corrugator for corrugating at least one web of sheet material as it passes through the sheet processing apparatus.

8. A sheet processing apparatus according to claim 1, further comprising laminating equipment for laminating a cover sheet onto a backing sheet, the cover sheet being the substantially continuous sheet of material after it has been printed upon by the digital printer.

9. A sheet processing apparatus according to claim 1, further comprising more than one printer.

10. A sheet processing apparatus according to claim 9, wherein at least two printers are provided for printing across the width of the substantially continuous sheet of material.

11. A sheet processing apparatus according to claim 1, wherein said the substantially continuous sheet of material is at least 2 m wide.

12. A sheet processing apparatus according to claim 1, comprising two or more digital printers arranged parallel to one another, but displaced out of line of one another.

13. A sheet processing apparatus according to claim 1, wherein the or each digital printer is arranged on a moveable carriage to allow the printer to be moved relative to the surface of the substantially continuous sheet onto which the printer is adapted to print.

14. A sheet processing apparatus according to claim 1, wherein the substantially continuous sheet is adapted to be moveable laterally within the apparatus, relative to the or each printer.

15. A sheet processing apparatus according to claim 1, comprising receiving equipment that rolls up the substantially continuous sheet after printing thereon.

16. A roll comprising a rolled sheet of material, the roll having a diameter of at least 300 mm and a width of at least 1 m, and the rolled sheet having extending along a substantial part of its length, on at least one surface thereof, a plurality of different printed images, each printed image, or at least the majority thereof, having a length of at least 300 mm and being destined for providing a printed covering of a predetermined product.

17. A method of providing printed products, the products having one or more printed image thereon, comprising providing a sheet processing apparatus according to claim 1, and printing images onto the substantially continuous sheet within the apparatus using the digital printer.

18. A method of providing printed products according to claim 17, wherein sequential print jobs are printed with a maximum spacial separation corresponding to no more than 10 image lengths.

19. A method of providing printed products according to claim 17, wherein more than one print job is printed at the same time within the apparatus, the print jobs being printed side by side.

20. A method of providing printed products according to claim 17, wherein the substantially continuous sheet has a feed speed of at least 100 mpm.
